(19) United States
(12) Patent Application Publication
(10) Pub. No.: US 2004/0013129 A1
(43) Pub. Date: Jan. 22, 2004

(54) Method and protocol for packetized optical channel based on digital wrapper

(76) Inventor: Xiaojun Fang, San Jose, CA (US)

Correspondence Address: Xiaojun Fang, 1040 S Winchester Blvd. #15, San Jose, CA, 95128, US

(21) Appl. No.: 10/178,145

(22) Filed: Jun. 22, 2002

Related U.S. Application Data
(60) Provisional application No. 60/310,403, filed on Aug. 7, 2001.
(60) Provisional application No. 60/315,206, filed on Aug. 27, 2001.

(51) Int. Cl. H04J 3/16; H04J 3/22

(52) U.S. Cl. 370/466

(57) ABSTRACT

This invention provides a method and device for generating and transporting packetized optical channels (POCH) and use them to carry TDM time slots and optical cells for sub-wavelength bandwidth management. The POCH emulates the standard G.709 optical channel frame and its default format consists of 240 68-byte time slots. Optical cells are mapped to the 68-byte POCH time slots either synchronously or asynchronously, where the synchronous cells have higher switching priority than the asynchronous cells. The POCH frame has 16-byte offset from the standard G.709 optical channel frame, and each frame has four 4080-byte sub-frames. Each sub-frame has 56 68-byte user time slots for payload and 4 overhead slots for optical channel overhead and forward error correction. Both the native time slots and the optical cells are switched by the POCH circuit-packet duality switch, to provide sub-wavelength level bandwidth and connection management and to serve as the physical transport layer for the unified TDM, ATM, and IP networks.

### CROSS-REFERENCE TO RELATED APPLICATIONS

This application claims the benefit and is a continuation-in-part of U.S. patent application Ser. No. 60/310,403, filed on Aug. 7, 2001, and U.S. patent application Ser. No. 60/315,206, filed on Aug. 27, 2001.

### FIELD OF THE INVENTION

This invention relates generally to telecommunication networks, in particular to optical transport networks. More specifically, it relates' to the efficient method of using the digital wrapper based wavelength channel to transport and switch time-division-multiplexed circuits and cells in the same wavelength.

### BACKGROUND AND SUMMARY OF THE INVENTION

The standard optical transport network today is the synchronous optical network (SONET) in the North America and the synchronous digital hierarchy (SDH) network in the rest of the world. The SONET/SDH network is a static circuit-switching network, its bandwidth granularity is STS-1/STM-0 which is about 51.83 Mbps. For example, a 2.488 Gbps OC-48 SONET pipe contains 48 STS-1 pipes, and these STS-1 bandwidth pipes connect network elements to provide transport services. Because of the rapid traffic growth from the Internet, dense wavelength division multiplexing (DWDM) network is widely deployed to boost network bandwidth. This high Internet traffic growth also leads to wide deployment of high capacity core IP routers and ATM switches, whose physical port speed has already reached OC-48c and OC-192c rate. It becomes impossible to use SONET/SDH network to connect such high-speed router ports because the port speed is the same as SONET/SDH line rate. For this reason, dedicated wavelengths or fibers are used to interconnect these high-speed IP router ports and ATM switch ports. A new optical transport network standard based on the digital wrapper and the DWDM technology is being defined by the International Telecommunication Union (ITU) to address this new transport network requirement. This new transport networking standard is called optical transport network (OTN), it provides transport functions by using wavelengths. Logically, the OTN network architecture is similar to the SONET/SDH network architecture, where the SONET section and line layers are correspondent to the optical transmission section (OTS) and the optical multiplex section (OMS) layers in the OTN model. The SONET path layer or STS-1 tributary is correspondent to the optical channel (OCH) in the OTN model. The OCH is based on the digital wrapper technology which is defined in the ITU G.709 standard. The OCH is carried by a wavelength in the DWDM systems. A wavelength connection across the OTN is also called a lightpath.

The OCH defined in the ITU G.709 standard has forward error correction (FEC) capability based on the RS(255, 239) code that has been used in the optical submarine systems (ITU G.975) for a long time.. A block of client data bytes is wrapped into an FEC frame with redundant parity bytes to increase the optical system link budget and non-regeneration transmission distance. This digital wrapper-based OCH signal not only contains the error correction function, it also has connection management capabilities, such as bit error rate (BER) monitoring, fault management, automatic protection switching (APS), communication channel for control, etc. The OCH/wavelength is the minimum bandwidth unit in the OTN network, which means the connection bandwidth can only be managed on the wavelength scale. Hence the OTN can only provide very coarse bandwidth management.

The OTN is developed to accommodate high bandwidth needs for the growing IP network, to provide point-to-point wavelength connections between pair ports of IP routers. All the sub-wavelength transport bandwidth management and switching functions are pushed into the IP layer in this IP over optics network model, which results in an inefficient and complex IP network with relatively poor quality of service (QoS). This type of IP network cannot support true TDM services and physical layer bandwidth management, and network operators have to manage two separate networks for the TDM and the IP, respectively. To have one unified network and to make the network more efficient and easy to manage, the transport function should be done in the physical layer, not in the IP layer. By providing a flexible and reliable transport layer, traffic engineering complexity in the IP network will also be reduced with improved service quality and lower operation cost. The physical layer of the optical transport network supports connection management for services, such as performance monitoring, fault demarcation, loopback, and other general purpose OAM&P functions. Even though future network will be IP centric, high-speed TDM premium services are still needed. Hence the transport network should support native TDM service and packet service in the same network, and be optimized for packet transport.

The present invention is a method and protocol of Packetized Optical Channel (POCH) for the optical transport network to enable sub-wavelength bandwidth management and statistical multiplexing gain for bursty traffic. The transmission frame format and transport overhead definition of the POCH is compatible with that of the standard ITU G.709 based OCH. Each OCH/POCH frame consists of four consecutive sub-frames, 4,080 bytes each. The POCH frame consists of multiple time slots for traffic mapping, and a time slot or fixed number of time slots carries a fixed size optical packet (cell) for packet switching. Both the true TDM circuit connections and the cell-based virtual connections can be mixed and transported within the same POCH channel. The POCH/OCH can be synchronized to an accurate network reference clock to satisfy the jitter and wander performance criteria of the TDM services. The fact that each time slot within the POCH can be handled either as a time slot or as an optical packet by the circuit-packet duality (CPD) switch makes the POCH persist advantages of both the circuit switching and the packet switching.

More particularly, the present invention is a method for transporting and switching optical cells and TDM time slots within the packetized OCH frames. Each cell has a header that carries connection IDs for packet switching. Some time slots in the POCH frame are switched as circuits by circuit switching. The POCH provides sub-wavelength layer optical transport networking functionality for the OTN to simplify IP network architecture and traffic engineering task. This invention provides a unified optical cell/slot switching technique with a physical layer transport switching device for bandwidth management and connection management in both the IP services and the TDM services.

### BRIEF DESCRIPTION OF THE FIGURES

FIG. 1 shows frame structure of the digital wrapper based optical channel (OCH) and its transmission sequence;

FIG. 2 shows frame structure of the packetized optical channel (POCH);

FIG. 3 is a view of POCH cell format of the present invention;

FIG. 4 shows the structure of the circuit-packet duality (CPD) switch for POCH cell and slot switching.

FIG. 5 is an example of optical transport network architecture with support for both the standard OCH and the POCH.

### DETAILED DESCRIPTION

The present invention provides a method and protocol of transporting and switching a plurality of fixed size optical packets (i.e., optical cells) and time slots within packetized optical channel (POCH) frames. The POCH frame is compatible with the standard ITU G.709 based optical channel (OCH) frame with fixed bytes of shift. The POCH frame is partitioned to a fixed number of time slots, and each time slot is used to carry a TDM circuit or an optical cell. All optical cells in the POCH frames have the same size, which may take one or multiple POCH time slot. Framing mechanism for the POCH is the same as the standard OCH channel. The POCH frame has 16-byte offset relative to the standard OCH frame, and all the OCH overhead bytes are maintained in the POCH frame. Further overhead bytes for POCH-specific management can be carried by one or more dedicated time slots within the POCH frame. Transmission of POCH cells and time slots is continuous and synchronous to the frame timing, hence each cell in the frame can also be switched as a time slot. Asynchronous optical cells in the POCH frame are mapped into the POCH frame at unspecified time slot locations and they are packet-switched using the connection IDs carried in the cell header. Time slots are circuit-switched using the time slot sequence number and a pre-defined circuit connection table.

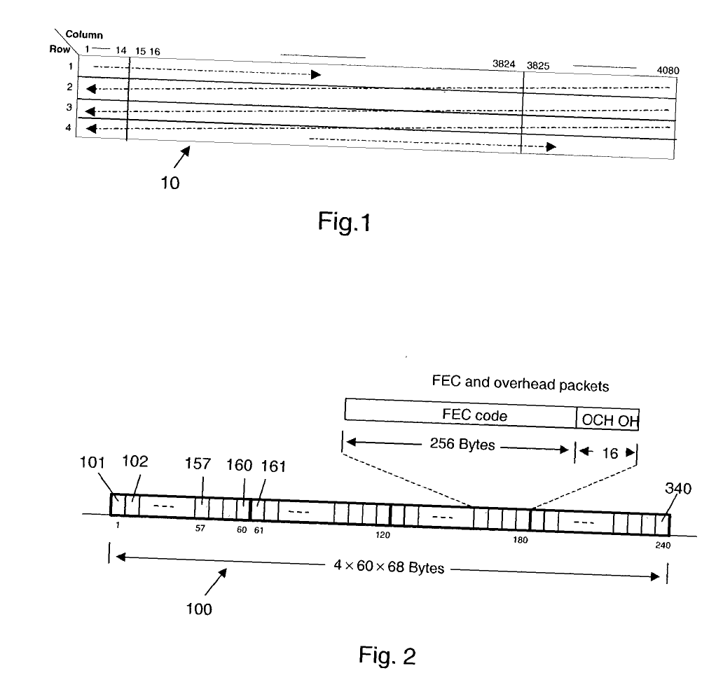

FIG. 1 shows the frame structure and the transmission sequence of a standard ITU G.709 based OCH frame of the prior art. Each OCH frame 10 has 4 rows and 4080 columns of bytes, where each 4080-byte row in the OCH frame 10 is an OCH sub-frame. The first 16 bytes in each sub-frame are OCH overhead bytes, the middle 3808 bytes are payload area to carry a client signal, and the last 256 bytes at the end are the forward error correction (FEC) bytes. The transmission sequence of the OCH frame is row by row, from left to right, as indicated in FIG. 1. Typical bit rate of the client signal carried within an OCH is OC-48, OC-192, or OC-768. The OCH bit rate is about 7% higher than the client signal bit rate.

The POCH frame is based on the OCH frame format with a 16-byte offset. FIG. 2 shows the structure of a POCH frame 100, with four sub-frames of 60×68 bytes each. The whole POCH frame has 240×68 bytes, the same as a standard OCH frame. The POCH frame is partitioned into integer number of time slots, and each time slot has 68 bytes. Among the 60 time slots in each sub-frame, the first 56 slots are payload slots (101, 102, etc.), and the last 4 slots in each sub-frame are OCH overhead slots (157, 160, etc.) to carry standard OCH overhead and FEC error correction bytes. As indicated in FIG. 1, each OCH sub-frame has 16 overhead bytes at the beginning and 256 FEC bytes at the end, the 256 FEC bytes are followed by the 16 overhead bytes of the next sub-frame. These 272 bytes are grouped into 4 68-byte slots in the POCH. It is easy to see that one difference between the POCH frame 100 and the standard OCH frame 10 of the prior art is that the POCH frame has 16 bytes offset from the standard OCH frame. Because the POCH keeps all the OCH overhead bytes and the FEC bytes in the same manner as in the OCH, the standard optical transport network elements cannot distinguish a POCH signal from an OCH signal. The POCH is also compatible with the standard OCH in terms of the OTN management systems, and it also provides additional optical packet switching capability to make the OTN flexible and cost effective. Three of four POCH overhead slots can be used for payload if the FEC is not used. The standard OCH is a wavelength connection for point-to-point applications, with support for a single client signal. The POTN supports multiple client signals, and the POCH adds and drops these client signals to provide flexible and reliable bandwidth pipes within the same wavelength. These sub-wavelength connections within a POCH wavelength are called virtual lightpath connections (VLC).

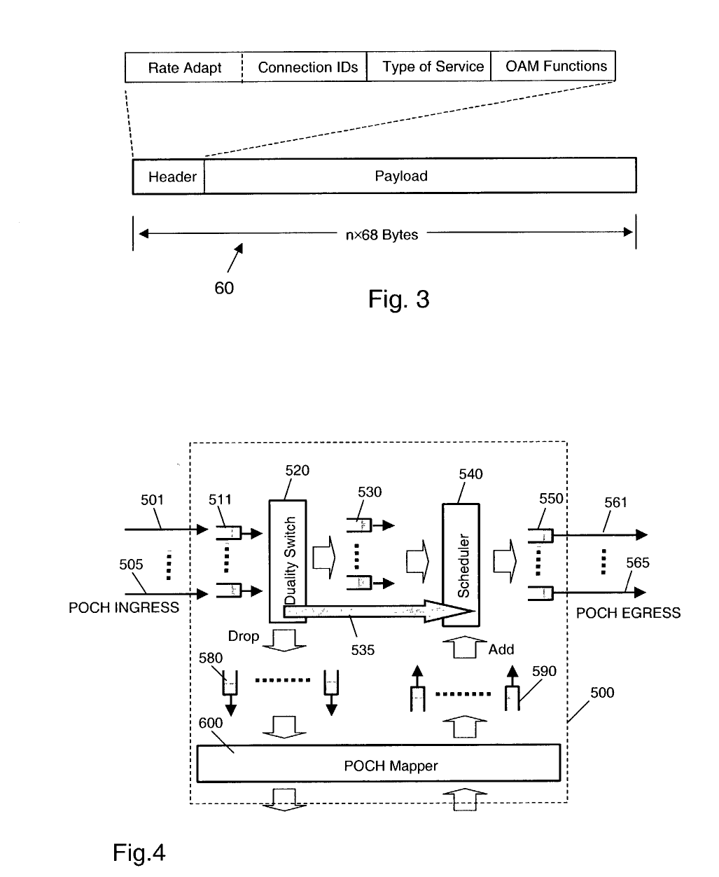

FIG. 3 shows the structure of an optical cell 60 to be mapped into one or a few time slots in the POCH frame 10. The optical cell 60 has header and payload area. The header contains information for VLC management, such as data rate adaptation, connection IDs, type of service (ToS) indicator, and OAM functions such as performance monitoring, digital communication channel, alarm indication, etc. Not all the header fields are mandatory, depending on the application, some can be neglected. The header can be minimum when the cell is used for a TDM connection and switched as a circuit. A POCH cell is mapped to the POCH frame and it occupies one or more 68-byte time slots. The size of a POCH cell is n×68 bytes long, with typical number for n to be 1, 2, or 4.

Other slot size can also be used to partition the POCH frame or the sub-frame into time slots. In general, if the size of the payload time slot is L bytes, one can partition the POCH frame or the POCH sub-frame based on the slot size. If the partition is based on the sub-frame, the number of time slots in a sub-frame will be the integer part of 4080/L. The reminder of the 4080/L will be used for fixed stuffing bytes in the sub-frame or to carry POCH overhead. The common way is to select the L that can divide the frame size or sub-frame size with no reminder. Because each frame has 4×60×68 bytes, many different numbers can be used for L, such as 60, 64, 68, etc. The default value for L is 68 in this invention because 4 such slots can exactly hold the FEC bytes and OCH overhead bytes in a sub-frame. The POCH can be considered as the generalized OCH, and the standard OCH can be considered as the concatenated POCH.

It is also possible to build the packetized OCH signal on the OCH payload area only. The 3808 payload bytes in a sub-frame is unwrapped from the FEC signal first, and the partition is done on the unwrapped signal, using 3808/L or 4×3808/L for the slot partitioning. In this embodiment, the sub-wavelength bandwidth management is done on the OCH client signal layer, and the unused OCH FEC overhead slots cannot be used for payload. Additional framing bytes and overhead are also needed for the 4×3808 bytes client data block. The partition on the client signal also makes this new network function a new functional layer in the network, and the operators have to maintain both the OCH layer network and the new packetized bandwidth management layer. For these reason, partition on the OCH directly is preferred.

For simplicity, all description in this invention assume 68 bytes as the size for both the time slot and the cell in the POCH frames, and the time slot partition is done directly on the OCH signal. Each POCH sub-frame has 60 68-byte time slots, and the whole POCH frame has 240 68-byte time slots. The POCH is the generalized version of the OCH and the OCH is the concatenated version of the POCH.

Different types of traffics, such as HDLC/GFP encapsulated IP/Ethernet/FR frames, ATM cells or TDM circuits, can be mapped into the same POCH channel and transported over the OTN using different virtual lightpath connections (VLC). The VLC can be either a packet switched connection or a circuit switched connection. The packet switched connection is a virtual connection whose bandwidth is flexible and statistical. The circuit switched connection is a true TDM connection, it is switched based on time slot count. An optical cell in the POCH can be switched either as a cell or as a time slot, depends on the service requirements. The fact that the POCH switch can switch a cell as either a cell or a time slot makes the whole POCH network persist circuit-packet duality. The VLC is the physical transport layer for the IP and TDM services with flexible and elastic bandwidth and protocol transparency. The VLC also makes the IP traffic bypass intermediate IP switches/routers to improve overall latency and jitter performance. This IP bypassing feature simplifies the IP router architecture and improves transport performance for services. This is because only a small portion of the IP traffic are dropped or added at an IP switching node, to create an express path for the bypassing traffics on the physical layer makes the IP switch simpler and cheaper. This new physical layer provides network connection management, such as loopback and bit-error-rate (BER) measurement for a VLC, which also makes the network management for the IP network more public telecommunication network alike.

Unlike the SONET/SDH signal that has fixed frame time, the POCH/OCH signal has fixed frame size. In a standard 16,320-byte OCH frame, 15,232 bytes are used for carrying the client signal. Hence the ratio between the OCH bit rate and the client signal bit rate is 15/14. For example, a POCH/OCH channel that carries an OC-48 (2.488 Gbps) client signal has bit rate of about 2.666 Gbps. A 68-byte time slot in such a POCH signal has bit rate of 2666/240=11.107 Mbps, and a 68-byte cell per frame with 64-byte payload has 10.454 Mbps payload capacity. Lower rate TDM signals can be multiplexed together and then mapped into the POCH slot. Higher rate TDM signals will occupy multiple POCH slots for transport. For example, the POCH with OC-48 payload capacity has 224 68-byte payload slots, and 14 slots per frame can carry an OC-3 signal. Hence the POCH switch can also add and drop SONET/SDH signals, by dropping the 14 slots that carry the OC-3 signal, an OC-3 signal is dropped from the POCH data stream. Timing adaptation for the TDM circuits into POCH can be done through re-synchronizing the client signal directly (such as SONET/SDH tributary) to the network clock. The timing adaptation can also be done by defining stuffing and pointer bytes in the TDM time slot or by using common time slots or special cells to carry the stuffing and pointer bytes for multiple TDM connections. Slot stuffing is also possible for timing adaptation of pass through traffic in a ring node. If through-timing is used in a ring network, no timing adaptation is needed for the pass-through traffic. The VLCs within the POCH channel serve as the physical ports or logical ports for the ATM switches and EP routers, to provide flexible and reliable physical transport connections for the IP-centric networks. The POCH switch switches SONET/SDH tributary signals in a similar way as a SONET/SDH add-drop multiplexer (ADM) does.

Because the POCH utilizes the framing mechanism defined in the standard OCH, it is possible for a POCH switch to locate the start and the end of each frame and the start and the end of each slot after the POCH frame is synchronized. Hence a POCH switch is able to identify frame and time slot boundaries in the frame. Network operators can provision certain time slots in the POCH frame for a circuit connection, and the time slots for this connection is switched in the circuit switching manner by the POCH switch using the provisioned circuit connection table and the time slot sequence counter. The POCH switch also switches optical cells in the packet switching manner, using the connection IDs carried in the cell header. The POCH cell switching is similar to ATM cell switching in the ATM networks.

FIG. 4 shows the architecture of a POCH switch. This switch is a circuit-packet duality switch that performs both circuit switching and packet switching. This switch identifies the time slots for a TDM circuit connection based on the provisioned connectivity table and the location of the time slot in the frame. Non-circuit connections are carried by the POCH cells. Unused slots in the POCH frame are stuffed with idle cells. The POCH switch handles cells based on the connection IDs and the type of service indicator carried in the cell header. The CPD switch has a plurality of ingress ports 501, 505, etc., and a plurality of ingress queues 511. The switching unit 520 drops or bypasses optical cells from the ingress queues. These cells and time slots to be dropped are switched to the drop queues 580, and these bypassing cells are switched to the bypass queues 530. Some drop-and-continue type cells or time slots are switched to both the drop queues and the bypass queues. The bypass queues support priority queuing based on service class. The cells and time slots to be added are queued first in the add queues 590. The cells and time slots queued in the bypass queues 530 and in the add queues 590 are switched to correspondent egress queues 550 controlled by the scheduler 540. The POCH mapper 600 maps different types of traffic into POCH cells or time slots. Both the drop queues 580 and the add queues 590 are per class per connection queuing. The switching on the OCH cells is based on the connection IDs carried in the cell header and the connectivity table stored in the switch node. For an operator-provisioned circuit connection, the traffic is directly mapped into the time slots with minimum header or even no header. The switch has tunneling mechanism for the TDM connections to directly transfer the correspondent time slots from the ingress queues and add queues to the egress queues through the circuit-switching tunnel 535. The time slot to be dropped is dropped into a circuit queue in the drop queue array 580.

Some optical cells are mapped into the POCH frame synchronously, using pre-allocated or pre-assigned time slots in every frame. The virtual connection based on the synchronous cells is called synchronous virtual connection and it has the highest priority among all the POCH cell types. This synchronous virtual connection has minimum jitter and predictable delay compared to asynchronous cell based virtual connections. The CPD switch 500 handles both time slots and cells, and it switches cells according to the priority level indicated in the class of service indictor in the cell header. The support for circuit switching in the POCH eliminates the need for the circuit emulation. Performance of the circuit emulation in the multi-protocol label switching (MPLS) based IP network is hard to satisfy the tight quality of service requirements from telecommunication customers, and a separate TDM network is normally required. This POCH based optical transport layer enables true TDM transport within the IP centric network, which unifies the IP network and the TDM network. The OTN protocol applies to most network topologies, such as ring, mesh, or linear.

The VLC in the POCH channel enables the OTN to provide transport service at sub-wavelength level with different priority levels. Both TDM circuits and packets are carried by the same wavelength, and the POCH can be provisioned as 100% circuits or 100% cells, or a mix. The VLCs have different priority levels and QoS requirements. The true circuit VLC has the highest priority and the best performance, it occupies pre-assigned time slots all the time even when there is no traffic to send. The second priority and QoS level for VLC is the synchronous VLC based on the synchronous cells. The synchronous cells of a VLC are mapped to the pre-assigned time slots, but the pre-assigned slots can also be used for asynchronous cells if they are not used. These top two QoS levels offered by the POCH network are unique and cannot be offered in the ATM or MPLS based IP network. The third priority and QoS level for VLC is asynchronous cell based explicit forwarding and assured forwarding, etc. There can be several priority sub-levels for the asynchronous cell based services alone, for example using the 4 class of service (CoS) levels defined in the IP networks. All these cell priority levels can be either indicated by an indicator in the cell header or by the connection IDs and the provisioned connectivity table in the switch node. All the VLCs share the same POCH physical bandwidth pipe to increase statistical multiplexing gain and to reduce mapping delay.

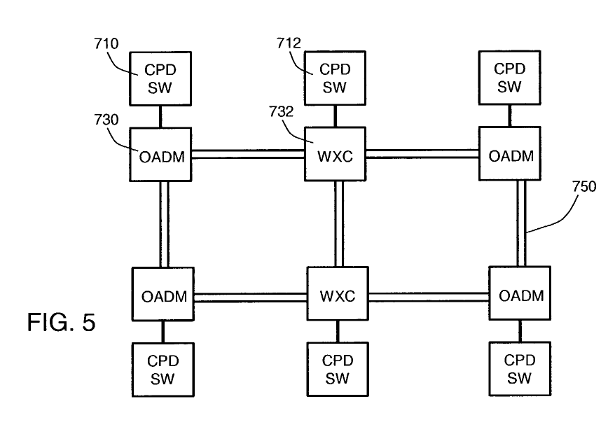

FIG. 5 shows an example of the optical transport network 750 with POCH duality switching enhancement. Dynamic optical add-drop multiplexer (OADM) 730 and wavelength cross-connect (WXC) 732 are used to manage wavelength connections. Each wavelength in the OTN carries a standard OCH channel or a POCH channel. Certain POCH wavelengths are dropped from the OADM node 730 and sent to the CPD switch 710 for sub-wavelength bandwidth grooming and switching. Signals from the egress ports of the CPD switch are added back into the OTN through the OADM or WXC. Pass-through wavelengths will bypass the OADM and WXC nodes, and pass-through VLCs within a POCH wavelength will bypass the CPD switches. The CPD switch only deals with these wavelengths being added or dropped at that node, so the scale of the CPD switch is small. By integrating the VLC bandwidth management function provided by the POCH protocol into the optical transport network, the optical transport network is capable of managing bandwidth on both the wavelength level and the sub-wavelength level with statistical multiplexing gain and service guarantee.

The invention has been described with respect to particular embodiments thereof, it is understood that numerous modifications can be made without departing from the spirit and scope of the invention as set forth in the claims.

What is claimed is:

1. A method and device of mapping, transporting and switching TDM time slots, synchronous cells and asynchronous cells within 16320-byte packetized optical channel frames, comprising
(a) generating 16,320-byte packetized optical channel frames that have four cascaded 4080-byte sub-frames in each frame, and
(b) partitioning the 16320-byte packetized optical channel frame into a plurality of fixed size time slots, and
(c) assigning fixed size cells to the time slots, and
(d) mapping user traffic into a virtual lightpath connection carried by time slots or cells, and
(e) switching the native time slots by circuit switching and switching cells by either packet switching or circuit switching with circuit-packet duality switching.

2. The method of claim 1, wherein the frame of the packetized optical channel has a 16-byte offset from the standard ITU G.709 optical channel frame of the prior art.

3. The method of claim 1, wherein default size for the time slot is 68 bytes.

4. The method of claim 1, wherein each 4080-byte sub-frame contains 3,808 payload bytes, followed by 256 forward error correction bytes and 16 optical channel overhead bytes.

5. The method of claim 1, wherein the time slot size is 60 bytes, 64 bytes, or multiples of 60, 64, or 68 bytes.

6. The method of claim 1, wherein all the cells have the same size, and each cell occupies one or multiple time slots.

7. The method of claim 1, wherein the cells are synchronously mapped to the pre-assigned time slots in the packetized optical channel.

8. The method of claim 1, wherein the cells are asynchronously mapped to some time slots in the packetized optical channel frame without time slot pre-assignment.

9. The method of claim 1, wherein the circuit switching means switching time slots using slot sequence indictor and circuit connectivity table, and the packet switching means switching cells using connection IDs within the cell header.

10. The method of claim 1, wherein the packetized optical channel contains 100% TDM time slots, 100% cells, or mix of TDM slots and cells.

11. The method of claim 4, wherein the payload bytes are partitioned into 56 cascaded 68-byte user time slots.

12. The method of claim 4, wherein the overhead and forward error correction bytes are contained in 4 cascaded 68-byte overhead time slots.

13. The method of claim 6, wherein the cell has header and payload area.

14. The method of claim 7 and claim 8, wherein the synchronous cells have higher priority than the asynchronous cells in packet switching.

15. The method of claim 8, wherein the asynchronous cells have multiple priority levels.

16. The method of claim 11, wherein some user time slots are used to carry network management information.

17. The method of claim 13, wherein the cell header contains connection identifiers and connection management overhead.
